(19) United States
(12) Patent Application Publication
(10) Pub. No.: US 2006/0144344 A1
(43) Pub. Date: Jul. 6, 2006

(54) PET RESTRAINT APPARATUS

(76) Inventors: James A. Stokes, Columbia, SC (US); Patsy L. Wallace, Columbia, SC (US)

Correspondence Address: NELSON MULLINS RILEY & SCARBOROUGH, LLP, 1320 MAIN STREET, 17TH FLOOR, COLUMBIA, SC, 29201, US

(21) Appl. No.: 10/990,154

(22) Filed: Nov. 16, 2004

Related U.S. Application Data
(63) Continuation of application No. 10/670,875, filed on Sep. 25, 2003, now abandoned.

(51) Int. Cl. A01K 27/00

(52) U.S. Cl. 119/858

(57) ABSTRACT

A pet restraint system may include a tether attached to a movable restraint member. The tether is attached to an animal's collar by means of a connector at one end and is affixed to the restraint member at the opposite end. The tether may be formed from a braided polyvinyl chloride (PVC) line threaded through a plurality of sheaths that prevent the tethering line from kinking or wearing as the pet moves within a fenced area.

This application is a continuation of U.S. patent application Ser. No. 10/670,875, filed on Sep. 25, 2003, the entire disclosure which is incorporated by reference herein.

### BACKGROUND OF THE INVENTION

Pet restraint systems often employ a tether for securing dogs or other pets within a designated area. Such design is advantageous because it allows the dog freedom of movement within the area prescribed by the tether. Such, prior systems require, however, that the tether be affixed to some stationary point, such as a pin or post. Because the tether is attached to a fixed point, the actual area available to the dog may be much less than the area the dog might otherwise reach.

Pet owners often forgo the use of a tether in favor of a fenced area, thus allowing a dog or pet complete freedom of movement within the area defined by the fence. However, dogs may sometimes burrow under fences and escape from the fenced area. Thus, while a fence offers advantages over a tether in that the dog may have more freedom within the fenced area, a fence presents a disadvantage in that the dog may burrow under the fence and escape.

### SUMMARY OF THE INVENTION

The present invention recognizes and addresses considerations of prior art constructions and methods and provides a pet restraint system for use in conjunction with a boundary fence, the pet restraint having a tether line having a first end and a second end, a harness for attaching the tether line to a pet, a connector attached to the tethering line first end, and a restraint anchor attached to the tether line second end. The restraint anchor defines respective widths in at least two orthogonal dimensions that are each larger than an expected cross-section width of a hole burrowed by the pet under the boundary fence. The tether may be composed of a braided polyvinyl chloride (PVC) line threaded through a plurality of sheaths that prevent the PVC tethering line from kinking or wearing as the animal moves within the fenced area.

The accompanying drawings, incorporated in and constituting part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a perspective view of an embodiment of a mobile pet restraint apparatus in accordance with the present invention;

FIG. 2 is a plan view of the restraint member shown in FIG. 1;

FIG. 3 is a plan view of connection means shown in FIG. 1;

FIG. 4 is a perspective view of the mobile pet restraint apparatus operating as described and in accordance with the present invention.

Repeat use of reference characters in the present specification and drawings is intended to represent same or analogous features or elements of the invention.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

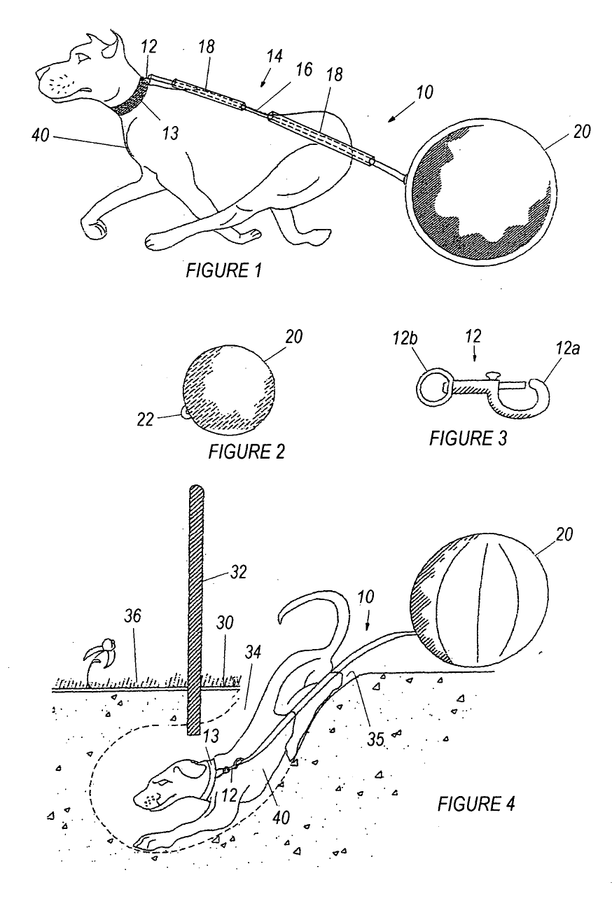

Referring to the drawings, and particularly to FIG. 1, an embodiment of the mobile pet restraint apparatus designated generally by the reference numeral 10 is described. Restraint apparatus 10 generally includes a connector 12, tether 14 and restraint anchor 20. Connector 12 may be a swivel eye bolt, a spring clasp or any other suitable fastener for attaching tether 14 to a pet 40 by means of a harness 13, for example a collar, shoulder harness or muzzle. In a preferred embodiment, connector 12 is a swivel eye bolt snap formed from aluminum alloy, as shown in FIG. 3, although it should be understood that connector 12 may be formed from any suitable metal alloy or polymer. A snap opening 12a of the swivel eye bolt snap 12 attaches the restraint apparatus 10 to harness 13, and a swivel eye 12b permanently connects to one end of tether 14 as illustrated in FIG. 1.

Tether 14 may be composed of a tethering line 16 and a plurality of sheaths 18. Line 16 may be of any length, and in a preferred embodiment, line 14 is between three and four feet. Line 16 may be formed from an elastic or inelastic material. In a preferred embodiment, line 16 is a ⅜-inch braided polyvinyl chloride line. Line 16 may be threaded through a plurality of sheaths 18 formed from a polymer, for example vinyl or any other suitable material that protects the line from kinking, wearing or tangling. Sheath 18 may be of length such that the sheaths slide along line 16 if necessary, as shown in FIG. 1. Moreover, in another embodiment, a plurality of sheaths may be provided to allow the line to bend, or sheath 18 may be eliminated where line 16 is formed from a durable material such as steel cable. Additionally, sheath 18 should have a sufficiently large inner diameter to allow the sheath to slide freely along line 16.

Referring to FIGS. 1 and 2, restraint anchor 20 is permanently attached to the opposite side of line 16 from swivel eye bolt snap 12 at connector 22. Line 16 may be attached by heat sealing the line to connector 22, tying tether line 16 to the connector, affixing a net to the end of line 16 that envelopes restraint anchor 20, or by any other suitable manner of attachment.

Restraint anchor 20 may be a hollow, light-weight sphere formed from plastic, rubber or other suitable material. For example, in a preferred embodiment, anchor 20 is formed from a semi-rigid plastic sphere, having a radius within the range of 10 inches to 32 inches depending on the size of the pet being restrained. Generally, regardless of the shape, the anchor will be a three dimensional shape. As indicated below, the shape may vary as desired and as suitable for a given pet, but preferably the anchor is of such a size that two of three orthogonal dimensions is larger than the maximum cross-sectional width of a hole the pet would be expected to dig under a fence. Of course, the desirable width will depend on the size of the pet and the pet's tendencies in digging holes. For example, restraint anchor 20 may preferably have a radius greater than one half the width of the shoulders of pet 40. While a spherical anchor is illustrated in the drawings, it should be understood that restraint anchor 20 may also be formed as a square, polygon, and tetrahedron or as a multi-lobed or multi-armed configuration so long as the anchor inhibits pet 40 from escaping under a fence.

In operation, restraint apparatus 10 is attached to harnessing apparatus 13 of pet 40, although apparatus 10 may also be connected to a shoulder harness or muzzle. As illustrated in FIG. 4, as pet 40 attempts to escape fenced area 30 by digging a tunnel 34 under fence 32, restraint anchor 20 prevents the pet from escaping the fenced area. That is, restraint anchor 20, being larger than opening 35 of tunnel 34, will not pass through the opening, thus preventing pet 40 from escaping to an area beyond the fence 36. In the event pet 40 becomes trapped due to lodging of the restraint anchor in some endangering position, for example around a tree or over the fence, the restraint apparatus may be used in conjunction with a particular form of harness known as a “break-away collar” or other suitable collar that will release pet 40 from apparatus 10 if sufficient force is imparted on the collar.

While one or more preferred embodiments of the invention have been described above, it should be understood that any and all equivalent realizations of the present invention are included within the scope and spirit thereof. The embodiments depicted are presented by way of example and are not intended as limitations upon the present invention. Thus, those of ordinary skill in this art should understand that the present invention is not limited to these embodiments since modifications can be made. Therefore, it is contemplated that any and all such embodiments are included in the present invention as may fall within the scope and spirit thereof.

1. A method of restraining a pet in conjunction with a boundary fence, said method comprising the steps of:
defining a maximum cross-sectional width of a hole the pet is expected to dig under the fence;
providing a sphere having a diameter larger than the maximum cross-sectional width; and
attaching the sphere to the pet.

2. A method of restraining a pet in conjunction with a boundary fence, said method comprising the steps of:
defining a maximum cross-sectional width of a hole the pet is expected to dig under the fence;
providing a pet restraint system comprising
a tether line having a first end and a second end,
a harness attached to the first end, and
a restraint anchor attached to the second end, wherein the restraint anchor defines respective widths in at least two orthogonal dimensions that are each larger than the maximum cross-sectional width; and
attaching the harness to the pet.

3. The method as in claim 2, wherein the pet restraint system includes a connector through which the harness attaches to the first end.

4. The method as in claim 2, including a snap bolt and a swivel eye through which the harness attaches to the first end.

5. The method as in claim 2, wherein the restraint anchor is a semi-deformable, hollow sphere.

6. The method as in claim 2, wherein the tether line is a polyvinyl chloride line.

7. The method as in claim 2, wherein the tether line is a steel cable.

8. The method as in claim 2, wherein the pet restraint system further comprises at least one elongated sleeve that surrounds the tether line between the harness and the restraint anchor.

9. The method as in claim 2, wherein the harness is a break away collar.

10. The method as in claim 2, wherein the harness is a shoulder harness.

11. The method as in claim 2, wherein each of the respective widths in the at least two orthogonal dimensions is greater than a width across shoulders of the pet.

12. A method of restraining a pet in conjunction with a boundary fence, said method comprising the steps of:
defining a maximum cross-sectional width of a hole the pet is expected to dig under the fence;
providing a pet restraint system comprising
a tether line having a first end and a second end,
a harness attached to the first end, and
a restraint anchor attached to the second end, wherein the restraint anchor defines respective widths in at least two orthogonal dimensions that are each larger than the maximum cross-sectional width; and
attaching the harness to the pet so that the tether line is releasably attached to the pet.

13. The method as in claim 12, wherein the pet restraint system includes a connector through which the harness attaches to the first end.

14. The method as in claim 12, wherein the pet restraint system includes a connector through which the harness attaches to the first end, the connector having a manually releasable clasp disposed at one end thereof and a non-releasable clasp disposed at an opposite end thereof.

15. The method as in claim 12, wherein the restraint anchor is formed from a semi-deformable polymer.

16. The method as in claim 15, wherein the semi-deformable polymer is rubber.

17. The method as in claim 12, wherein the tether line is an elastic material.

18. The method as in claim 12, wherein the tether line is a metal alloy material.

19. The method as in claim 13, wherein the pet restraint system includes at least one elongated sleeve that surrounds the tether line between the connector and the restraint anchor.

20. The method as in claim 12, wherein each of the respective widths in the at least two orthogonal dimensions is greater than a width across shoulders of the pet.

21. The method as in claim 1, wherein the sphere is hollow.

22. The method as in claim 21, wherein the attaching step includes attaching the hollow sphere to the pet by a tether line.

23. The method as in claim 1, wherein the pet is a dog.

24. (canceled)

25. (canceled)

26. (canceled)

27. (canceled)

28. (canceled)

29. (canceled)

30. (canceled)

31. (canceled)

32. (canceled)
